(19) United States
(12) Patent Application Publication
(10) Pub. No.: US 2026/0063937 A1
(43) Pub. Date: Mar. 5, 2026

(54) ELECTRO-OPTIC MODULATOR INCLUDING OPTICAL AND ELECTRICAL SIGNAL PATHS VIA GLASS CORE SUBSTRATE

(71) Applicant: OPTILAB, LLC, Phoenix, AZ (US)

(72) Inventors: Henry Hung, Paradise Valley, AZ (US); Xiaoyan Ying, Phoenix, AZ (US); Leijun Yin, Tempe, AZ (US); Ke Huang, Phoenix, AZ (US)

(21) Appl. No.: 18/821,871

(22) Filed: Aug. 30, 2024

(51) Int. Cl. G02F 1/035

(52) U.S. Cl. CPC G02F 1/0356; G02F 2202/20

(57) ABSTRACT

Various thin film modulator based hybrid-integrated electro-optic (EO) components compatible with 2.5D, 3D, and integrated laser 3D co-packaged optics integration technique. The hybrid-integrated electro-optic (EO) components use a glass core substrate to route optical signals and electrical signals between devices mounted directly or indirectly to the glass core substrate. The optical signal routing path within the glass core substrate may include one or more optical via holes, one or more mirror or reflectors, one or more lenses, high index waveguide, mode spot or field converters, and optical couplers including inverse tapered and tapered high index waveguides. The electrical signal routing paths within the glass core substrate may include a set of metal layers and a set of metallized via holes.

### BACKGROUND

### Field

Aspects of the present disclosure relate generally to optical modulators, and in particular, to electro-optic modulator including optical and electrical signal paths via glass core substrate.

### Background

Long-haul telecommunication networks, data center optical interconnects, and microwave photonic systems heavily rely on lasers to generate the essential optical carrier for data transmission. Typically, lasers function as standalone units, separate from the modulators, leading to increased system costs and reduced stability and scalability. The emerging approach of Co-Packaged Optics (CPO) aims to address these issues by integrating lasers, modulators, and other essential photonic components into a single package. This integration not only reduces the physical footprint of optical systems but also enhances performance by minimizing losses and improving thermal management. CPO technology promises to revolutionize optical communications by providing a more efficient, cost-effective, and scalable solution for high-speed data transmission across various applications.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

An aspect of the disclosure relates to a hybrid-integrated electro-optic (EO) modulator. The hybrid-integrated EO modulator includes a glass core substrate including an optical via hole; an electro-optic (EO) modulator mounted over the glass core substrate and optically coupled to the optical via hole; and a waveguide including a mirror or reflector mounted under the glass core substrate, wherein the waveguide and the mirror or reflector are optically coupled to the optical via hole.

Another aspect of the disclosure relates to a hybrid-integrated electro-optic (EO) modulator. The hybrid-integrated EO modulator includes a substrate; a cladding layer disposed over the substrate; a waveguide optically coupled to the laser source; a mirror or reflector optically coupled to the waveguide, wherein the waveguide and mirror or reflector are embedded between the cladding layer and the substate; and an EO modulator optically coupled to the mirror or reflector, wherein the optical modulator is disposed over the cladding layer.

Another aspect of the disclosure relates to a hybrid-integrated electro-optic (EO) component. The hybrid-integrated ED component includes a glass core substrate; and a set of optical signal processing devices mounted over the glass core substrate, wherein the glass core substrate comprises a set of one or more optical paths optically coupling two or more of the set of optical signal processing devices.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the description embodiments are intended to include all such aspects and their equivalents.

### BRIEF DESCRIPTION OF THE DRAWINGS

FIG. 1 illustrates a block diagram of an example electro-optic (EO) transceiver in accordance with an aspect of the disclosure.

FIGS. 2A-2C illustrate respectively a pair of perspective views and a top view of example hybrid-integrated electro-optic (EO) transceivers in accordance with another aspect of the disclosure.

FIG. 3 illustrates a side sectional view of an example hybrid-integrated electro-optic (EO) modulator including an example external-laser-to-modulator optical signal routing paths in accordance with another aspect of the disclosure.

FIG. 4 illustrates a side sectional view of another example hybrid-integrated electro-optic (EO) modulator including an example external-laser-to-modulator optical signal routing path in accordance with another aspect of the disclosure.

FIG. 5 illustrates a side sectional view of another example hybrid-integrated electro-optic (EO) modulator including example electrical signal routing paths in accordance with another aspect of the disclosure.

FIGS. 6A-6B illustrate respectively perspective and top views of other example hybrid-integrated optical transceivers in accordance with another aspect of the disclosure.

FIG. 7 illustrates a side sectional view of an example hybrid-integrated electro-optic (EO) modulator including an example integrated-laser-to-modulator optical signal routing path in accordance with another aspect of the disclosure.

FIG. 8 illustrates a side sectional view of another example hybrid-integrated electro-optic (EO) modulator including an example integrated-laser-to-modulator optical signal routing path in accordance with another aspect of the disclosure.

FIG. 9 illustrates a side sectional view of another example hybrid-integrated electro-optic transceiver in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

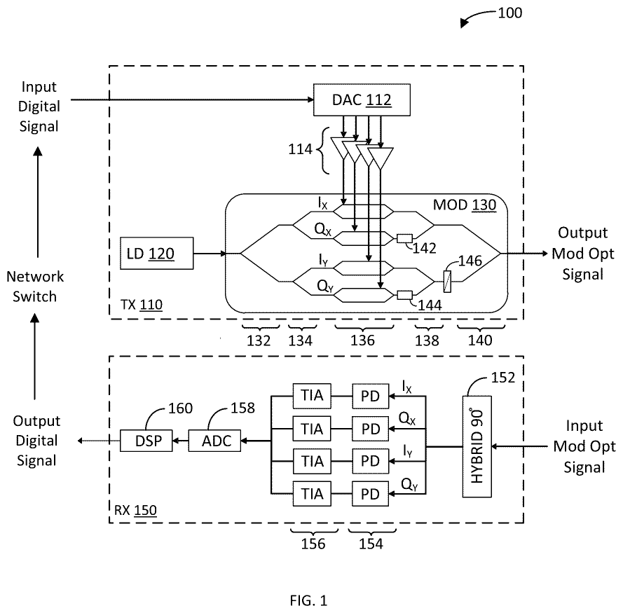

FIG. 1 illustrates a block diagram of an example electro-optic (EO) transceiver 100 in accordance with an aspect of the disclosure. The EO transceiver 100 includes a transmitter 110 and a receiver 150. For explanation purpose, the EO transceiver 100 shown pertains to a single transmit/receive data channel pair. It shall be understood that an EO transceiver may include a set of EO transceivers pertaining to a set of data transmit/receive data channel pairs, respectively.

The transmitter 110 includes a digital-to-analog converter (DAC) 112, a set (e.g., four (4)) of radio frequency (RF) drivers or amplifiers (e.g., low noise amplifiers (LNAs)) 114, and an EO modulator 130 (e.g., a dual polarization quadrature phase shift keying (DP-QPSK) modulator), and a laser source or diode (LD) 120. The DAC 112 is configured to generate a set (e.g., four (4)) RF signals based on an input digital signal received from a network switch. The set of RF drivers 114 is configured to amplify the set of RF signals. The LD 120 is configured to generate a continuous wave (CW) laser.

The EO modulator 130 includes first and second hierarchical splitters 132 and 134 configured to split the CW laser into four (4) CW beams. The EO modulator 130 includes a set (e.g., four (4)) electro-optic (EO) modulators 136 (e.g., bulk lithium niobate (LN) or thin film lithium niobate (TFLN)) configured to modulate the set of CW lasers with the set of RF signals to generate a set of dual polarization (X-Y) QPSK (IQ) modulated optical signals I_{X}, Q_{X}, I_{Y}, and Q_{Y}. The EO modulator 130 further includes a first set (e.g., two (2)) of hierarchical combiners 138 including respective 90-degree hybrids 142 and 144, and a second hierarchical combiner 140 including a polarization beam combiner 146, all of which collectively are configured to combine the set of DP-QPSK modulated optical signals into an output modulated optical signals for transmission to a remote device via, for example, a single-mode optical fiber.

The receiver 150, in turn, includes a 90-degree hybrid 152, a set (e.g., four (4)) of photodetectors (PDs) 154, a set (e.g., four (4)) of transimpedance amplifiers (TIAs), an analog-to-digital converter (ADC) 158, and a digital signal processor (DSP) 160. The 90-degree hybrid 152 is configured to split an input modulated optical signal into a set (e.g., four (4)) DP-QPSK modulated optical signals I_{X}, Q_{X}, I_{Y}, and Q_{Y}. The set (e.g., four (4)) of PDs 154 and the set (e.g., four (4)) of TIAs 156 are configured to convert the set of DP-QPSK modulated optical signals I_{X}, Q_{X}, I_{Y}, and Q_{Y} into a set of analog electrical signals. The ADC 158 is configured to convert the set of analog signals into a set of digital signals. The DSP 160 is configured to digitally process (e.g., symbol demodulation, error correction, etc.) the set of digital signals to generate an output digital signal. The output digital signal is provided to the network switch.

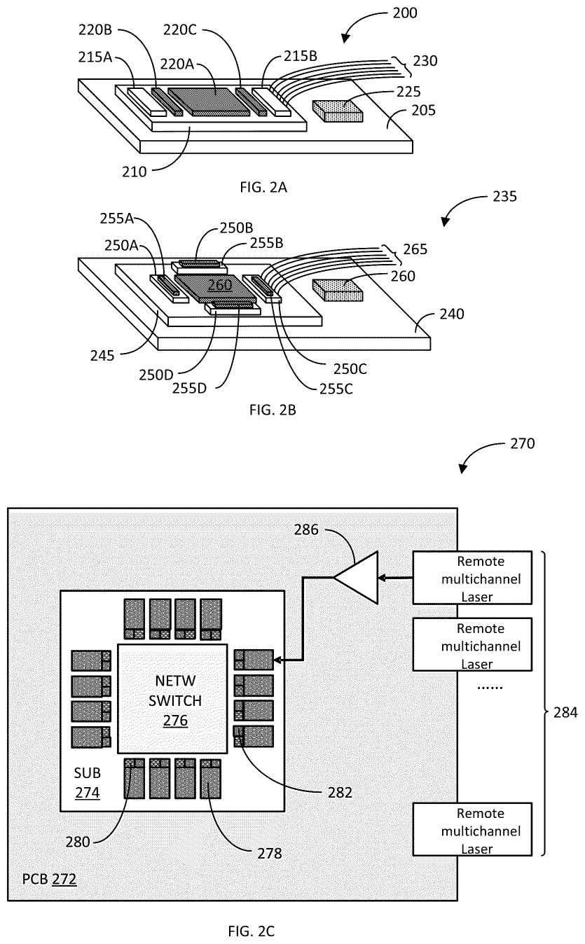

FIG. 2A illustrates a perspective view of an example hybrid-integrated electro-optic (EO) transceiver 200 in accordance with another aspect of the disclosure. The hybrid-integrated optical transceivers 200 may be integrated in accordance with co-packaged optics (CPO) techniques. For example, the hybrid-integrated optical transceiver 200 may be implemented in accordance with a 2.5 dimensional (D) CPO technique, where optical engines (e.g., EO modulators, 90-degree hybrid) share the same substrate as electrical components (e.g., network switch, DACs, drivers, PDs, TIAs, ADCs, DSPs). The substrate may be mounted on a printed circuit board (PCB), which, in turn, hosts a laser source or diode (LD).

In particular, the EO transceiver 200 includes a PCB 205, a substrate (e.g., a glass core or silicon substrate) 210 mounted on and electrically coupled to the PCB 205, a set of optical engines 215A and 215B (e.g., depicted as non-shaded components) mounted on and optically/electrically to the substrate 210 and electrically coupled to the PCB 205 via the substrate 210, and a set of electrical components (e.g., depicted as shaded components) mounted on and electrically coupled to the substrate 210 and PCB 205 via the substrate 210. As mentioned, the set of optical engines 215A and 215B may include a set of EO modulators for modulating a continuous wave (CW) with a set of RF signals associated with a set of data channels, respectively. The electrical component 220A may be a network switch, and the set of electrical components 220B and 220C may be DACs, drivers, PDs, TIAs, ADCs, and DSPs.

The EO transceiver 200 further includes a laser source or diode (LD) 225 mounted on and electrically coupled to (e.g., receive power from) the PCB 205 and optically coupled (e.g., provide a CW laser) to the optical engines 215A and 215B via the substrate 210, which may include both optical and electrical paths for routing optical and electrical signals, respectively. Additionally, the EO transceiver 200 includes a set of optical fibers 230 for transmitting a set of modulated output optical signals to remote device(s) and receive a set of modulated input optical signals from remote device(s).

FIG. 2B illustrates a perspective view of another example hybrid-integrated electro-optic (EO) transceiver 235 in accordance with another aspect of the disclosure. The hybrid-integrated optical transceivers 235 may be integrated in accordance with co-packaged optics (CPO) techniques. For example, the hybrid-integrated optical transceiver 235 may be implemented in accordance with a 3D CPO technique, where some electrical components (e.g., DACs, drivers, PDs, TIAs, ADCs, DSPs) may be mounted on optical engines (e.g., EO modulators, 90-degree hybrid), which are, in turn, mounted and electrically/optically coupled to a substrate. Other electrical engines (e.g., network switch) maybe mounted on and electrically coupled to the substrate. The substrate may be mounted on a printed circuit board (PCB), which, in turn, may host a laser source or diode (LD).

In particular, the EO transceiver 235 includes a PCB 240, a substrate (e.g., glass core or silicon substrate) 245 mounted on and electrically coupled to the PCB 240, a set of optical engines 250A-250D (e.g., depicted as non-shaded components) mounted on and optically/electrically coupled the substrate 245 and electrically coupled to the PCB 240 via the substrate 245, and a set of electrical components 255A-255D (e.g., depicted as shaded components) mounted on and electrically coupled to the substrate 245 and PCB 240 via the substrate 245, respectively. As mentioned, the set of optical engines 250A-250D may include a set of EO modulators for modulating a continuous wave (CW) with a set of RF signals associated with a set of data channels, respectively. The set of electrical components 255A-255D may include DACs, drivers, PDs, TIAs, ADCs, DSPs associated with a set of data channels.

The EO transceiver 235 further includes a laser source or diode (LD) 260 mounted on and electrically coupled to (e.g., receive power from) the PCB 240 and optically coupled (e.g., provide CW laser) to the optical engines 250A-250D via the substrate 245, which includes both optical and electrical paths for routing optical and electrical signals, respectively. Additionally, the EO transceiver 235 includes a set of optical fibers 265 for transmitting a set of modulated output optical signals to remote device(s) and receive a set of modulated input optical signals from remote device(s).

FIG. 2C illustrates a perspective view of an example hybrid-integrated electro-optic (EO) transceiver 270 in accordance with another aspect of the disclosure. The hybrid-integrated electro-optic (EO) transceiver 270 may be implemented in accordance with 2.5D or 3D CPO integration technique.

The EO transceiver 270 includes a PCB 272, a substrate 274 (e.g., glass core or silicon substrate) mounted on and electrically coupled to the PCB 272, and a set of optical engines 278 mounted on and optically/electrically coupled to the substrate 274 and electrically coupled to the PCB 272 via the substrate 274. The EO transceiver 270 may further include a set of electrical devices (e.g., a set of DSPs 280 and a set of TIAs 282) mounted on and electrically coupled to the substate 274 and PCB, or mounted on the set of optical engines 278 and electrically coupled to the substrate 274 and PCB 272. The sets of optical engines 278, DSPs 280, and TIAs 282 may pertain to a set of data channels. The EO transceiver 270 may further include a network switch 276 mounted on and electrically coupled to the PCB 272 via the substrate 274, and to the sets of optical engines 278, DSPs 280, and TIAs via optical/electrical paths within the substrate 274.

The EO modulator 270 may further include a set of multichannel laser sources or diodes (LDs) 284, which may be remote (e.g., off the PCB 272) or mounted on the PCB 272, pertaining to the set of data channels, respectively. The EO modulator 270 may further include a set of optical amplifiers (e.g., erbium-doped fiber amplifier (EDFA) or other type) 286 (e.g., one shown for explanation purposes) for amplifying CW lasers generated by the set of LDs 284, respectively. The set of optical amplifiers 286 may be optically coupled to the set of optical engines 278 to provide thereto a set of amplified CW lasers pertaining to the set of data channels, respectively.

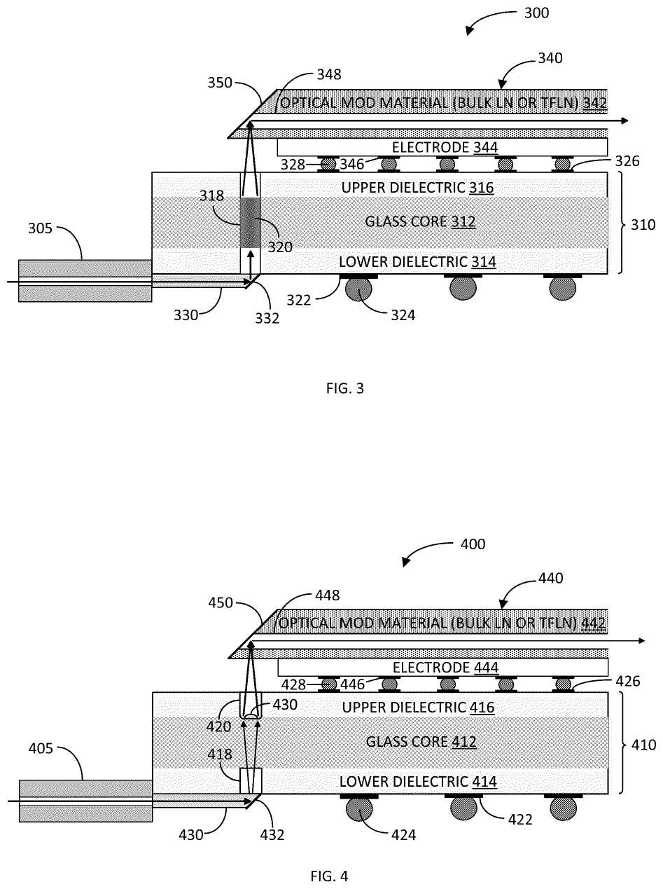

FIG. 3 illustrates a side sectional view of an example hybrid-integrated electro-optic (EO) modulator 300 in accordance with another aspect of the disclosure. The hybrid-integrated EO modulator 300 may be integrated in accordance with 2.5D or 3D CPO. The hybrid-integrated EO modulator 300 includes an optical signal path for routing an optical signal to and from an EO modulator.

In particular, the hybrid-integrated EO modulator 300 includes a glass core substrate 310 including a glass core 312 sandwiched between a lower dielectric (e.g., silicon oxide SiO₂, or other) layer 314 and an upper dielectric (e.g., silicon oxide SiO₂, or other) layer 316. The glass core substrate 310 may include a lower set of metal pads 322/ball grid array (BGA) 324 for electrically attaching to a printed circuit board (PCB), as previously discussed with reference to EO transceivers 200, 235, and 270. The glass core substrate 310 may further include an optical via hole 318 extending from and through the lower dielectric layer 314 via the glass core 312 and to and through the upper dielectric layer 316. A lens (e.g., focusing microlens) 320, such as a gradient-index (GRIN) lens, may be formed within the optical via hole 318. The glass core substrate 310 may further include an upper set of metal pads 326/BGA 328 for electrically coupling to an electro-optic (EO) modulator 340 via its own set of metal pads 346.

The hybrid-integrated electro-optic (EO) modulator 300 further includes a high index waveguide 330 (e.g., ion-exchanged glass, high refractive index polymers, silicon nitride (Si₃N₄), silicon oxynitride (SiON), or amorphous silicon) including a mirror or reflector 332 (e.g., a substantially 45-degree microreflector). The high index waveguide 330 includes an input (e.g., left) side coupled to a single-mode optical fiber 305 to receive a CW laser from a remote or PCB mounted laser source or diode. The mirror or reflector 332 may be positioned directly below the optical via hole 318. Accordingly, the waveguide 330 receives and routes the CW signal propagating in a substantially horizontal direction to the mirror or reflector 332, which redirects the CW laser in an upward vertical direction for propagation through the optical via hole 318 via the lens 320.

The EO modulator 340 includes an optical modulating material 342 (e.g., bulk lithium niobate (LN) or thin film lithium niobate (TFLN)). An electrode (e.g., RF signal transmission line) 344 may be formed on the bottom of the optical modulating material 342. The electrode 344 may include a set of metal pads 346 electrically coupled to the set of metal pads 326 of the glass core substrate 310 via the BGA 328, for example, receiving an RF signal and/or a DC bias voltage via metal layers and vias within the glass core substrate 310. The optical modulating material 342 includes a substantially horizontal extending optical modulating waveguide 348 and a mirror or reflector 350 formed at an internal surface of the optical modulating material 342 on an input (e.g., left) side of the optical modulating waveguide 348. The mirror or reflector 350 is situated above the optical via hole 318 of the glass core substrate 310 to receive the vertically-upward propagating CW laser therefrom, and redirect it in a substantially horizontal direction for propagation via the optical modulating waveguide 348. The lens 320 is configured to change (e.g., decrease) a mode field diameter of the CW laser for efficient coupling into the optical modulating waveguide 348 as its diameter may be smaller than the mode field diameter of the CW laser prior to propagating through the lens 320.

In summary, the glass core substrate 310 of the hybrid-integrated EO modulator 300 facilitates an optical path including the input single-mode optical fiber 305, high index waveguide 330, mirror or reflector 332, optical via hole 318 including the lens, mirror or reflector 350 at an internal surface of the optical modulating material 342, and the optical modulating waveguide 348.

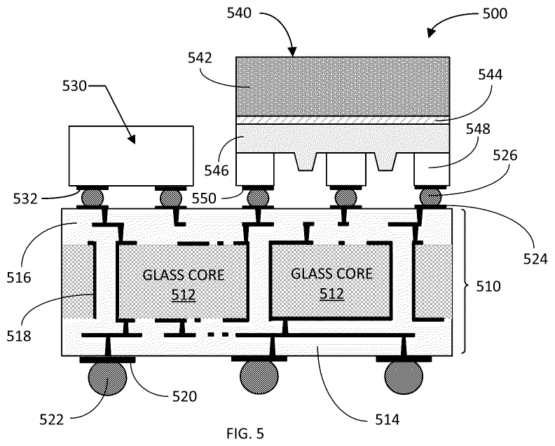

FIG. 4 illustrates a side sectional view of another example hybrid-integrated electro-optic (EO) modulator 400 in accordance with another aspect of the disclosure. The hybrid-integrated EO modulator 400 may be integrated in accordance with 2.5D or 3D CPO. The hybrid-integrated EO modulator 400 includes an optical signal path for routing an optical signal to and from an EO modulator.

In particular, the hybrid-integrated EO modulator 400 includes a glass core substrate 410 including a glass core 412 sandwiched between a lower dielectric (e.g., SiO₂, or other) layer 414 and an upper dielectric (e.g., silicon oxide SiO₂, or other) layer 416. The glass core substrate 410 may include a lower set of metal pads 422 for electrically attaching to a printed circuit board (PCB) via a ball grid array (BGA) 424, as previously discussed with reference to EO transceivers 200, 235, and 270. The glass core substrate 410 includes a lower optical via hole 418 extending through the lower dielectric layer 418 and terminating at the bottom of the glass core 412. The glass core substrate 410 includes an upper optical via hole 420 extending through the upper dielectric layer 420 from the top of the glass core 412. The lower and upper optical vias holes 418 and 420 may be substantially vertically aligned. A lens (e.g., a focusing laser ablated microlens) 430 may be formed from (e.g., by chemical or laser etching) and at the top surface of the glass cores substrate 412. The glass core substrate 410 may further include an upper set of metal pads 426 for electrically coupling to an electro-optic (EO) modulator 440 by way of a ball grid array (BGA) 428.

The hybrid-integrated electro-optic (EO) modulator 400 further includes a high index waveguide 430 (e.g., ion-exchanged glass, high refractive index polymers, silicon nitride (Si₃N₄), silicon oxynitride (SiON), or amorphous silicon) including a mirror or reflector 432 (e.g., a substantially 45-degree microreflector). The high index waveguide 430 includes an input (e.g., left) side coupled to a single-mode optical fiber 405 to receive a CW laser from a remote or PCB mounted laser source or diode. The mirror or reflector 432 is positioned directly below the lower optical via hole 418. Accordingly, the waveguide 430 receives and routes the CW signal propagating in a substantially horizontal direction to the mirror or reflector 432, which redirects the CW laser in an upward vertical direction for propagation via the lower optical via hole 418, the glass core 412, the lens 430, and the upper optical via hole 420.

The EO modulator 440 includes an optical modulating material 442 (e.g., bulk LN or TFLN). An electrode (e.g., RF signal transmission line) 444 may be formed on the bottom of the optical modulating material 452. The electrode 444 may include a set of metal pads 446 electrically coupled to the set of metal pads 426 of the glass core substrate 410 via the BGA 428, for example, receiving an RF signal and/or a DC bias voltage via metal layers and vias within the glass core substrate 410. The optical modulating material 442 includes a substantially horizontal extending optical modulating waveguide 448 and a mirror or reflector 450 formed at an internal surface of the optical modulating material 442 on an input side of the optical modulating waveguide 448. The mirror or reflector 450 may be situated directly above the upper optical via hole 420 of the glass core substrate 410 to receive the vertically-upward propagating CW laser therefrom, and redirect it for substantially horizontal propagation via the optical modulating waveguide 448. The lens 430 is configured to change (e.g., decrease) a mode field diameter of the CW laser for efficient coupling into the optical modulating waveguide 448 as its diameter may be smaller than the mode field diameter of the CW laser prior to propagating through the lens 430.

In summary, the glass core substrate 410 of the hybrid-integrated EO modulator 400 facilitates an optical path including the input single-mode optical fiber 405, high index waveguide 430, mirror or reflector 432, lower optical via hole 418, glass core 412, lens 430, upper optical via hole 420, mirror or reflector 450 at an internal surface of the optical modulating material 452, and the optical modulating waveguide 448.

FIG. 5 illustrates a side sectional view of another example hybrid-integrated electro-optic (EO) modulator 500 in accordance with another aspect of the disclosure. The hybrid-integrated EO modulator 500 may be integrated in accordance with 2.5D or 3D CPO. The hybrid-integrated EO modulator 500 includes electrical routing paths for electrical signals between a PCB, electrical devices mounted on a glass core substrate, optical devices mounted on the glass core substrate.

In particular, the hybrid-integrated EO modulator 500 includes a glass core substrate 510 including a glass core 512, a lower dielectric (e.g., SiO₂) layer 514, and an upper dielectric (e.g., SiO₂) layer 516. The glass core substrate 510 includes a lower set of metal pads 520 on its bottom surface for electrically attaching and connecting to a printed circuit board (PCB) via a ball grid array (BGA) 522, as previously discussed with reference to EO transceivers 200, 235, and 270. The glass core substrate 510 includes an upper set of metal pads 524 on its top surface for electrically attaching and connecting to electrical or electro-optical components, such as driver 530 and EO modulator 540 via a BGA 526 and their respective sets of metal pads 532 and 550.

Similar to multilayer PCBs and semiconductor substrates, the glass core substrate 512 includes various metal layers and metallized via holes, collectively identified with reference number 518 for routing electrical signal (e.g., RF and/or control signals)/power (e.g., supply voltage) between the PCB and driver 530, between the PCB and EO modulator 540, and/or between the driver 530 and the EO modulator 540. In this example, the EO modulator 540 may be implemented as a flip-chip including an upper electronic section 546 and standoffs 548 for electrically/mechanically connecting to the glass core substrate 510 via a set of metal pads 550. The EO modulator 540 includes an optical modulation waveguide 544, and a lower substrate portion 542. The glass core substrate 510 may be the same glass core substrate 310 or 410 of (EO) modulator 300 or 400 so as to provide a single substrate solution for optical and electrical signal routing paths.

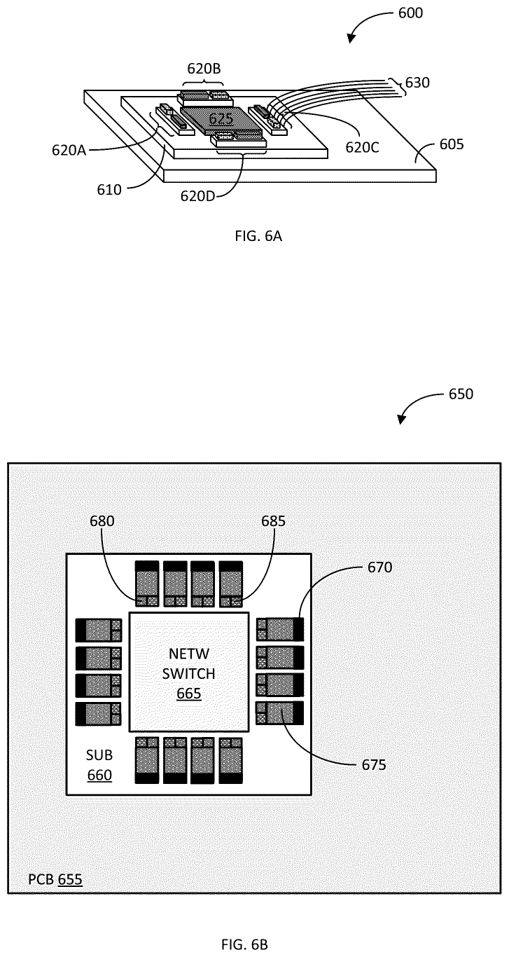

FIG. 6A illustrates a perspective view of an example hybrid-integrated electro-optic (EO) transceiver 600 in accordance with another aspect of the disclosure. The hybrid-integrated optical transceivers 600 may be integrated in accordance with co-packaged optics (CPO) techniques. For example, the hybrid-integrated EO transceiver 600 may be implemented in accordance with integrated laser 3D CPO technique, where some electrical components (e.g., DACs, drivers, PDs, TIAs, ADCs, DSPs) and laser sources may be mounted on optical engines (e.g., EO modulators, 90-degree hybrid), which are, in turn, mounted and electrically coupled to a substrate. Other electrical engine(s) (e.g., network switch) maybe mounted on and electrically coupled to the substrate. The substrate may be mounted on a printed circuit board (PCB).

In particular, the hybrid-integrated EO transceiver 600 includes a PCB 605, a substrate (e.g., a glass core or silicon substrate) 610 mounted on and electrically coupled to the PCB 605, a set of integrated laser sources/electrical components mounted on a set of optical engines 620A-620D, respectively, which, in turn, are mounted on and optically/electrically coupled to the substrate 610, and electrically coupled to the PCB 605 via the substrate 610. As mentioned, the set of optical engines of the integrated electrical/optical components 620A-620D may include a set of EO modulators for modulating a set of continuous wave (CW) lasers generated by the set of integrated lasers with a set of RF signals associated with a set of data channels, respectively. The set of electrical components the integrated electrical/optical components 620A-620D include DACs, drivers, PDs, TIAs, ADCs, DSPs associated with a set of data channels, respectively. The hybrid-integrated EO transceiver 600 may further include a network switch 625 mounted on and electrically coupled to the substrate 610 and to the PCB 605 via the substrate 610. Additionally, the EO transceiver 600 includes a set of optical fibers 630 for transmitting a set of modulated output optical signals to remote device(s) and receive a set of modulated input optical signals from remote device(s).

FIG. 6B illustrates a perspective view of an example hybrid-integrated electro-optic (EO) transceiver 650 in accordance with another aspect of the disclosure. The hybrid-integrated EO transceiver 650 may be implemented in accordance with integrated laser 3D CPO integration technique.

The hybrid-integrated EO transceiver 650 includes a PCB 655, a substrate 660 (e.g., glass core or silicon substrate) mounted on and electrically coupled to the PCB 655, and a set of integrated laser sources 670/optical engines 675/DSPs 680/TIAs 685 mounted on and optically/electrically coupled to the substrate 660 and electrically coupled to the PCB 655 via the substrate 660. The sets of integrated laser sources 670, optical engines 675, DSPs 680, and TIAs 685 pertain to a set of data channels, respectively. The hybrid-integrated EO transceiver 650 may further include a network switch 665 mounted on and electrically coupled to the PCB 655 via the substrate 660.

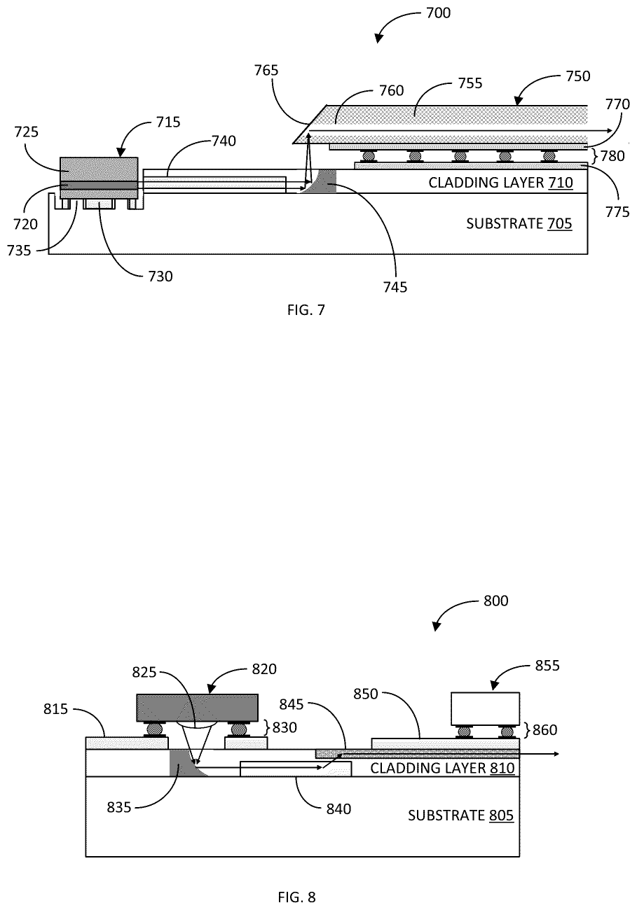

FIG. 7 illustrates a side sectional view of an example hybrid-integrated electro-optic (EO) modulator 700 including an integrated laser source in accordance with another aspect of the disclosure. The hybrid-integrated EO modulator 700 includes a substrate (e.g., Si) 705, a cladding layer (e.g., SiO₂ or polymer) 710 disposed over the substrate 705, a high index waveguide 740 and a mirror or reflector (e.g., a parabolic or substantially 45-degree microreflector) 745, both mounted on the substrate 705 and embedded within the cladding layer 710. The EO modulator 700 further includes a distributed feedback laser (DFB) laser 715, for example, in the form of a flip-chip, mounted (e.g., solder 730 to metal pads) between pedestals 735 formed on the top surface of the substrate 705. The DFB laser 715 includes an active region 720 configured to emit a continuous wave (CW) laser, and a substrate portion 725 above the active region 720. The active region 720 is substantially horizontally aligned with the high index waveguide 740.

The hybrid-integrated EO modulator 700 includes an EO modulator 750 includes an EO modulating material 755 (e.g., bulk LN or TFLN) including an optical modulating waveguide 760 extending substantially horizontal within the optical modulating material 755. The EO modulator 750 further includes a substantially 45-degree mirror or reflector 765 formed at an internal surface of the EO modulator 750 proximate an input (e.g., left) side of the optical modulating waveguide 760. The EO modulator 750 includes a bottom electrode (e.g., RF signal transmission line) 770 electrically coupled to a top electrode 775, disposed over the cladding layer 710, via sets of upper metal pads/ball grid array (BGA)/lower metal pads 780 associated with an electrical interface between the EO modulator 750 and substrate 705/cladding layer 710.

As shown by arrow lines, the active region 720 of the DFB laser 715 is configured to emit a CW laser, which propagates substantially horizontal to an input (e.g., left end) of the high index waveguide 740. The CW laser propagates substantially horizontal from the input to an output (e.g., right end) of the high index waveguide 740, wherein the mode field diameter of the CW laser may be changed (e.g., decreased) for efficient coupling into the optical modulating waveguide 760 of the EO modulator 750. The CW laser exits the output of the high index waveguide 740, where it is redirected by the mirror or reflector 745 in an upward vertical direction towards the substantially 45-degree mirror or reflector 765 of the EO modulator 750. The 45-degree mirror or reflector 765 then redirects the vertically upward propagating CW laser in a substantially horizontal direction for propagation via the optical modulating waveguide 760.

An RF signal associated with a data channel may be provided to the electrode 770 via, for example, the electrode 775 and lower metal pads/BGAs/upper metal pads 780 of the electrical interface between the substrate 705/cladding layer 710 and the EO modulator 750. In this configuration, the CW laser propagating within the optical modulating waveguide 760 gets modulated with the RF signal on the electrode 770 due to the electromagnetic/index of refraction interaction properties of the optical modulating material (e.g., the bulk LN or TFLN) 755. The modulated output signal exits the optical modulating waveguide 760 at an output (e.g., right) end thereof.

In summary, the hybrid-integrated EO modulator 700 includes an optical path including the DFB laser 715, high index waveguide 740, mirror or reflector 745, mirror or reflector 765 at an internal surface of the optical modulating material 755, and the optical modulating waveguide 760.

FIG. 8 illustrates a side sectional view of an example hybrid-integrated electro-optic (EO) modulator 800 including an integrated laser source in accordance with another aspect of the disclosure. The EO modulator 800 includes a substrate (e.g., Si or glass core substrate) 805, a cladding layer (e.g., SiO₂ or polymer) 810 disposed over the substrate 805, a mirror or reflector (e.g., a parabolic or substantially 45-degree microreflector) 835, and an inverse tapered high index waveguide 840, both mounted on the substrate 805 and embedded within the cladding layer 810. The hybrid-integrated EO modulator 800 further includes a vertical cavity surface emitting laser (VCSEL) 820 electrically coupled and attached to an electrode 815 disposed over the cladding layer 810 via a set of upper metal pads/BGAs/lower metal pads 830. The VCSEL 820 further includes a focusing lens (e.g., microlens) 825 situated on its underside and substantially vertically aligned with the mirror or reflector 835.

The hybrid-integrated EO modulator 800 includes an optical (e.g., TFLN) modulating waveguide 845 extending substantially horizontal over the cladding layer 810. The optical modulating waveguide 845 includes a tapered input portion overlying an inverse tapered output portion of the high index waveguide 840. The hybrid-integrated EO modulator 800 further includes another electrode (e.g., RF signal transmission line) 850 extending substantially parallel with and overlying the optical modulating waveguide 845. A driver/TIA 855 integrated chip 855 may be mounted on and electrically coupled to the electrode 850 via a set of upper metal pads/BGAs/lower metal pads 860.

As shown by arrow lines, the VCSEL is configured to emit a CW laser, which propagates vertically downwards via the lens 825, where it is focused on the mirror or reflector 835. The mirror or reflector 835 redirects the vertically downward propagating CW laser substantially horizontally towards an input (e.g., left end) of the inverse tapered high index waveguide 840. The CW laser propagates substantially horizontal from the input towards an output portion (e.g., right end) of the inverse tapered high index waveguide 840, while changing (e.g., decreasing) a mode field diameter of the CW laser for efficient coupling into the optical modulating waveguide 845. As the inverse tapered output portion of the waveguide 840 is situated below the tapered input portion of the optical modulating waveguide 845, the CW laser evanescently couples upwards into the optical modulating waveguide 845 for substantially horizontal propagation therethrough.

The driver/TIA 855 is configured to generate an RF signal associated with a data channel, which is provided to the electrode 850 overlying and extending parallel with the optical modulating waveguide 845. In this configuration, the CW laser propagating within the optical modulating waveguide 845 gets modulated with the RF signal on the electrode 850 due to the electromagnetic/index of refraction interaction properties of the optical (e.g., TFLN) modulating waveguide 845. The modulated output signal exits the optical modulating waveguide 845 at an output (e.g., right) end thereof.

In summary, the hybrid-integrated EO modulator 800 includes an optical path including the VCSEL 820, lens 825, mirror or reflector 835, inverse tapered high index waveguide 840, and the optical modulating waveguide 845.

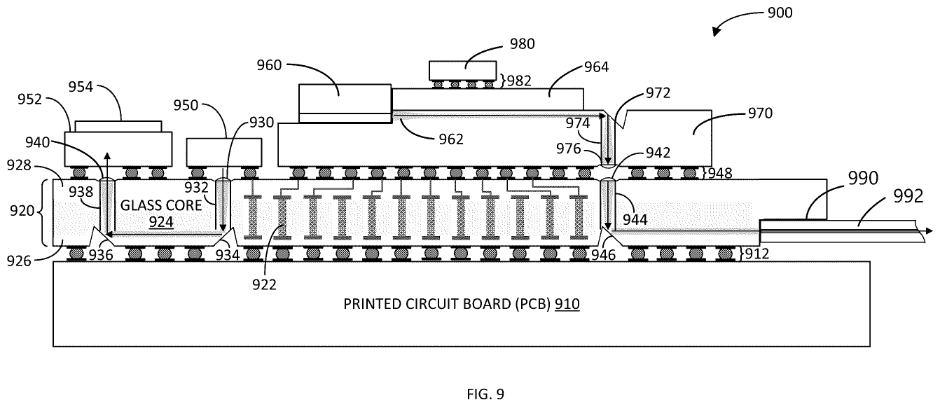

FIG. 9 illustrates a side sectional view of another example hybrid-integrated electro-optic (EO) component 900 in accordance with another aspect of the disclosure. The hybrid-integrated EO component 900 may be integrated in accordance with integrated laser 3D co-packaged optics (CPO) techniques.

In particular, the hybrid-integrated EO component 900 includes a printed circuit board (PCB) 910, a glass core substrate 920 mounted on an electrically coupled to the PCB 910 via a set of upper metal pads/BGAs/lower metal pads 912. The glass core substrate 924 includes a glass core 924 sandwiched between a lower dielectric (e.g., SiO₂) layer 926, and an upper dielectric (e.g., SiO₂) layer 928.

Various components are directly and/or indirectly mounted on and are electrical and/or optically coupled to the glass core substrate 920. For example, as discussed in more detailed further herein, the hybrid-integrated EO component 900 includes a VCSEL laser 950 mounted on and electrically/optically coupled to the glass core substrate 920 via a first set of upper metal pads/BGAs/lower metal pads 948 and a first optical path, respectively. The hybrid-integrated EO component 900 also includes a heterogenous integrated chip 954 mounted on a silicon photonics chip 952, which is mounted on and electrically/optically coupled to the glass core substrate 920 via the first set of upper metal pads/BGAs/lower metal pads 948 and the first optical path, respectively.

The hybrid-integrated EO component 900 also includes a DFB laser 960 and an EO (e.g., TFLN) modulator 964, both mounted on a substrate (e.g., Si) 970, which, in turn, is mounted and electrical/optically coupled to the glass core substrate 920 via the first set of upper metal pads/BGAs/lower metal pads 948 and a second optical path, respectively. The hybrid-integrated EO component 900 includes a driver chip 980, which may be mounted on and electrically coupled to the EO modulator 964 via a second set of upper metal pads/BGAs/lower metal pads 982. The hybrid-integrated EO component 900 further includes an output single-mode optical fiber 992 optically coupled to the second optical path, and situated in a microfabricated U-groove 990 formed on an exterior surface of the glass core substrate 920.

From an electrical perspective, the heterogeneous integrated chip 954, silicon photonics chip 952, VCSEL laser 950, DFB laser 960, and driver chip 980 may be electrically coupled to the PCB 910 (and to each other if appropriate) via a set of internal metal layers and metallized via holes within the glass core substrate 920, as collectively represented by reference number 922

From an optical perspective, the first optical path begins with the VCSEL 950 generating a vertically downward CW laser, which passes through a focusing lens 930 (e.g., a femtosecond laser-etched microreflector lens) formed (e.g., by chemical or laser etching) at the top surface of the upper dielectric layer 928 of the glass core substrate 920. Continuing with the first optical path, the CW laser, after passing downward through the lens 930, enters an optical via hole 932 formed within the glass core substrate 925. The CW laser propagates downward by way of the optical via hole 932 to a substantially 45-degree mirror or reflector 934 (e.g., a femtosecond laser-etched microreflector) formed within the lower dielectric layer 926 of the glass core substrate 920.

Continuing with the first optical path, the substantially 45-degree mirror or reflector 934 redirects the vertically-downward propagating CW laser substantially horizontal to the left where it propagates via the glass core 924 to another substantially 45-degree mirror or reflector 936 (e.g., a femtosecond laser-etched microreflector) formed within the lower dielectric layer 926 of the glass core substrate 920. The substantially 45-degree mirror or reflector 936 redirects the substantially horizontal propagating CW laser vertically upwards through another optical via hole 938 formed within the glass core substrate 920. The CW laser propagates upwards by way of the optical via hole 938 to a diverging lens 940 (e.g., a femtosecond laser-etched microreflector lens) formed at the top surface of the upper dielectric layer 928 of the glass core substrate 920. The lens 940 diverges the CW laser for optically coupling into an optical port at the underside of the silicon photonics chip 952.

The second optical path begins with the DFB laser 960 emitting a substantially horizontal propagating CW laser. The hybrid-integrated EO component 900 includes an optical waveguide mode spot converter 962 configured to change (e.g., decrease) a mode field diameter of the CW laser. The CW laser then propagates substantially horizontally via an optical modulating waveguide situated within a top portion of the substrate 970 directly below the EO modulator 964, wherein the CW laser gets modulated with an RF signal generated by the driver 980. The modulated optical signal then propagates to a substantially 45-degree mirror or reflector 972 (e.g., a femtosecond laser-etched microreflector) formed at a top surface of the substrate 970, where the modulated optical signal gets redirected in a vertically downward direction. After being redirected by the substantially 45-degree mirror or reflector 972, the modulated optical signal propagates downward by way of an optical via hole 974 formed within the substrate 970.

Continuing with the second optical path, the hybrid-integrated EO component 900 includes another diverging lens 976 (e.g., a femtosecond laser-etched microreflector lens) formed at the bottom surface of the substrate 970. The diverging lens 976 diverges the modulated optical signal to another focusing lens 942 (e.g., a femtosecond laser-etched microreflector lens) formed at the top surface of the upper dielectric layer 928 of the glass core substrate 920. The focusing lens 942 focuses the modulated optical signal into an optical via hole 944 formed within the glass core substrate 920. The modulated optical signal flows vertically downward by way of the optical via hole 944 to a substantially 45-degree mirror or reflector 946 (e.g., a femtosecond laser-etched microreflector), where the modulated optical signal gets redirected in a rightward substantially horizontal direction. The modulated optical signal then propagates substantially horizontal within the glass core 924 to the output single-mode optical fiber 992 for transmission to a remote device.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A hybrid-integrated electro-optic (EO) modulator, comprising:
a glass core substrate including an optical via hole;
an electro-optic (EO) modulator mounted over the glass core substrate and optically coupled to the optical via hole; and
a waveguide including a first mirror or reflector mounted under the glass core substrate, wherein the waveguide and the first mirror or reflector are optically coupled to the optical via hole.

2. The hybrid-integrated EO modulator of claim 1, further comprising a lens situated within the optical via hole.

3. The hybrid-integrated EO modulator of claim 2, wherein the lens comprises a gradient-indexed (GRIN) lens.

4. The hybrid-integrated EO modulator of claim 1, wherein the glass core substrate includes a glass core sandwiched between an upper dielectric layer and a lower dielectric layer, wherein the optical via hole includes an upper optical via hole through the upper dielectric layer, and a lower optical via hole through the lower dielectric layer, and wherein the upper via hole is substantially vertically aligned with the lower via hole.

5. The hybrid-integrated EO modulator of claim 4, further comprising a lens formed at an upper end of the glass core directly below the upper via hole.

6. The hybrid-integrated ED modulator of claim 5, wherein the lens comprises a laser ablated lens.

7. The hybrid-integrated ED modulator of claim 1, wherein the EO modulator includes an optical modulating material comprising an optical modulating waveguide and a second mirror or reflector formed at an internal surface of the optical modulating material proximate an input end of the optical modulating waveguide, wherein the second mirror or reflector is optically coupled to the optical via hole of the glass core substrate.

8. The hybrid-integrated ED modulator of claim 1, wherein the EO modulator further includes an electrode formed on the optical modulating material, wherein the glass core substrate includes one or more metal layers and one or more metalized via holes for routing an RF signal and/or a DC bias voltage to the electrode of the EO modulator.

9. A hybrid-integrated electro-optic (EO) modulator, comprising:
a substrate;
a cladding layer disposed over the substrate;
a laser source mounted over the substrate;
a waveguide optically coupled to the laser source;
a first mirror or reflector optically coupled to the waveguide, wherein the waveguide and mirror or reflector are embedded between the cladding layer and the substate; and
an EO modulator optically coupled to the first mirror or reflector.

10. The hybrid-integrated EO modulator of claim 9, wherein the laser source comprises a distributed feedback (DFB) laser.

11. The hybrid-integrated EO modulator of claim 10, wherein an optical signal path is defined including the DFB laser configured to generate a continuous wave (CW) laser, the waveguide configured to receive the CW laser, the waveguide configured to route the CW laser to the first mirror or reflector, and the first mirror or reflector configured to redirect the CW laser in a vertical direction towards the EO modulator disposed over the cladding layer.

12. The hybrid-integrated EO modulator of claim 11, wherein the waveguide is configured to change a mode field diameter of the CW laser.

13. The hybrid-integrated EO modulator of claim 11, wherein the first mirror or reflector comprises a parabolic mirror or reflector.

14. The hybrid-integrated EO modulator of claim 11, wherein the first mirror or reflector comprises a substantially 45-degree mirror or reflector.

15. The hybrid-integrated EO modulator of claim 11, wherein the EO modulator includes an optical modulating material comprising an optical modulating waveguide and a second mirror or reflector formed at an internal surface of the optical modulating material proximate an input end of the optical modulating waveguide, wherein the optical signal path includes the second mirror or reflector configured to redirect the CW laser from the first mirror or reflector in a substantially horizontal direction for propagating via the optical modulating waveguide.

16. The hybrid-integrated EO modulator of claim 9, wherein the laser source comprises a vertical cavity surface emitting laser (VCSEL).

17. The hybrid-integrated EO modulator of claim 16, wherein an optical signal path is defined including the VCSEL configured to generate a continuous wave (CW) laser, a focusing lens configured to focus the CW laser upon the first mirror or reflector, the first mirror or reflector configured to redirect the CW laser from the focusing lens in a substantially horizontal direction, and the waveguide configured to redirect the CW laser from the first mirror or reflector towards the EO modulator.

18. The hybrid-integrated EO modulator of claim 17, wherein the EO modulator comprises an optical modulating waveguide, wherein the optical signal path includes the waveguide evanescently coupled to the optical modulating waveguide.

19. The hybrid-integrated EO modulator of claim 17, wherein the optical modulating waveguide is disposed over the cladding layer, and further comprising:
an electrode disposed over the optical modulating waveguide; and
an RF driver disposed over the electrode, wherein the RF driver is configured to generate and provide an RF signal to the electrode for modulating the CW laser propagating via the optical modulating waveguide.

20. A hybrid-integrated electro-optic (EO) component, comprising:
a glass core substrate; and
a set of optical signal processing/transmission devices mounted over the glass core substrate, wherein the glass core substrate comprises a set of one or more optical paths optically coupling two or more of the set of optical signal processing/transmission devices.

21. The hybrid-integrated EO component of claim 20, wherein the set of optical signal processing devices includes a laser source and a photonic chip, wherein the set of one or more optical paths includes a first optical path optically coupling the laser source to the photonic chip.

22. The hybrid-integrated EO component of claim 21, wherein the first optical path includes a first optical via hole extending vertically downward from the laser source to a first mirror or reflector, a second mirror or reflector situated substantially horizontally with respect to the first mirror or reflector, and a second optical via hole extending vertically upwards towards the photonic chip.

23. The hybrid-integrated EO component of claim 22, wherein the first optical path includes a focusing lens between the laser source and the first optical via hole, and a diverging lens between the second optical via hole and the photonic chip.

24. The hybrid-integrated EO component of claim 20, wherein the set of optical signal processing/transmission devices includes an electro-optic (EO) modulator and a single-mode optical fiber, wherein the set of one or more optical paths includes a first optical path optically coupling the EO modulator to the single-mode optical fiber.

25. The hybrid-integrated EO component of claim 24, wherein the first optical path includes an optical via hole extending vertically downward from the EO modulator to a mirror or reflector, wherein the single-mode optical fiber is situated substantially horizontally with respect to the mirror or reflector.

26. The hybrid-integrated EO component of claim 25, wherein the first optical path includes a focusing lens between the EO modulator and the optical via hole.
